(19) United States
(12) Patent Application Publication
(10) Pub. No.: US 2015/0123582 A1
(43) Pub. Date: May 7, 2015

(54) MOTOR DRIVING APPARATUS AND CONTROLLING METHOD THEREOF

(71) Applicant: SAMSUNG ELECTRO-MECHANICS CO., LTD., Suwon-si (KR)

(72) Inventor: Bon Young Gu, Suwon-si (KR)

(73) Assignee: SAMSUNG ELECTRO-MECHANICS CO., LTD., Suwon-si (KR)

(21) Appl. No.: 14/191,105

(22) Filed: Feb. 26, 2014

(30) Foreign Application Priority Data
Nov. 1, 2013 (KR) 10-2013-0132358

(51) Int. Cl. H02P 6/18

(52) U.S. Cl. CPC H02P 6/182
USPC 318/400.35

(57) ABSTRACT

Disclosed herein is a motor driving apparatus, including: an inverter applying a direct current voltage to the respective phases of a brushless DC (BLDC) motor by a switching operation; and a motor driver detecting counter electromotive force patterns in floating sections of the respective phases, detecting zero cross points (ZCPs) of the respective phases using the counter electromotive force patterns, and then generating a PWM signal for controlling a switching operation of the inverter and a phase switching of the respective phases using position information of the zero cross points (ZCPs).

### CROSS REFERENCE TO RELATED APPLICATION

This application claims the benefit of Korean Patent Application No. 10-2013-0132358, filed on Nov. 1, 2013, entitled “Apparatus and Method for Driving Motor”, which is hereby incorporated by reference in its entirety into this application.

### BACKGROUND OF THE INVENTION

1. Technical Field

The present invention relates to a motor driving apparatus and a controlling method thereof.

2. Description of the Related Art

In general, since a direct current motor (DC motor) has a linear relationship between an applied voltage and a speed, it has a simple speed control and a wide speed control range. However, the DC motor has a brush as an essential component to maintain torque in one direction. Therefore, it was difficult to drive at a high speed due to the brush, maintenance was frequent due to abrasion of the brush, and a noise, or the like was serious.

In order to solve the above-mentioned problems, a brushless DC motor (called a BLDC motor) was suggested, wherein the brushless DC motor is configured by a stator having a coil wound in a direction opposite to a typical DC motor and a rotor having a permanent magnet and obtains rotation force by controlling a current flowing in the coil of the stator to thereby control magnetic flux of the stator and magnetic flux of the permanent magnet of the rotor so as to have a right angle or any angle.

Since the BLDC motor does not include the brush, it solves disadvantages of the DC motor according to the prior art, and since it has advantages of the DC motor as it is, it has been recently and widely used. In order to appropriately control magnetic flux, a switching state of inverter switching devices needs to be determined so that a magnetic generation position of the stator is determined depending on a position of the rotor. In order to detect the position of the rotor, even though a sensor such as a hall sensor, or the like may be used, a sensor-less scheme detecting position information of the rotor by detecting a zero cross point (ZCP) by counter electromotive force without using the sensor is mainly used due to environmental factors such as a temperature, a pressure, and the like.

Therefore, in the above-mentioned sensor-less scheme, according to the prior art, as described in the following prior art document, the zero cross point (ZCP) is detected by comparing the counter electromotive force of the respective phases induced from the stator with a reference voltage. In the BLDC motor, in the case in which an error is generated in the phase voltage and the reference voltage due to mismatch of an inductor, and the like, an accuracy of the detection of the zero cross point (ZCP) is decreased, such that a position detection of the rotor may become uneven and a timing of switching a phase of the motor may become irregular.

### PRIOR ART DOCUMENT

### Patent Document

(Patent Document 1) 2006-0068844KR

### SUMMARY OF THE INVENTION

The present invention has been made in an effort to provide a motor driving apparatus capable of securing reliability in driving a BLDC motor by detecting zero cross points (ZCPs) of the respective phases using counter electromotive force patterns in floating sections of the respective phases and a reference pattern, and a controlling method thereof.

According to a preferred embodiment of the present invention, there is provided a motor driving apparatus, including: an inverter applying a direct current voltage to the respective phases of a brushless DC (BLDC) motor by a switching operation; and a motor driver detecting counter electromotive force patterns of the respective phases by sampling counter electromotive force values in floating sections of the respective phases, and detecting zero cross points (ZCPs) of the respective phases by comparing the counter electromotive force patterns and a reference pattern with each other.

The motor driver may generate a PWM signal for controlling a switching operation of the inverter and a phase switching of the respective phases using position information of the zero cross points (ZCPs).

The inverter may include transistors controlled by the PWM signal of the motor driver and diodes each connected to the transistors in anti-parallel.

The motor driver may form the counter electromotive force patterns of the respective phases by converting the sampled counter electromotive force values into digital values and sequentially storing the digital values and then detect the zero cross points (ZCPs) of the respective phases by comparing the counter electromotive force patterns with a preset reference pattern.

The motor driver may include: at least one analog-to-digital (A/D) converter converting the sampled counter electromotive force values of the respective phases into digital values; and at least one register sequentially storing the digital values.

The register may be a flip-flop.

The motor driver may include: a ZCP detecting module detecting the zero cross points (ZCPs) of the respective phases by comparing the counter electromotive force patterns detected in the floating sections of the respective phases with the reference pattern; a controlling module measuring a position and a rotation speed of a rotor using information of the detected zero cross points (ZCPs); and a PWM signal generating module generating a PWM signal for controlling phase switching timings of the respective phases based on the position of the rotor and speed information of the motor.

The motor driver may include an initial driving circuit providing information for the zero cross points (ZCPs) for performing the phase switching of the respective phases to the PWM signal generating module at the time of initially driving.

The ZCP detecting module may include: a U phase detecting circuit including a first converter converting a counter electromotive force value sampled in a floating section of a U phase into a digital value and a first register sequentially storing the digital value; a V phase detecting circuit including a second converter converting a counter electromotive force value sampled in a floating section of a V phase into a digital value and a second register sequentially storing the digital value; a W phase detecting circuit including a third converter converting a counter electromotive force value sampled in a floating section of a W phase into a digital value and a third register sequentially storing the digital value; a pattern detecting circuit detecting the counter electromotive force patterns of the respective phases using the digital value stored in the first to third registers; and a ZCP detecting circuit detecting the zero cross points (ZCPs) of the respective phases by comparing the counter electromotive force patterns with a preset reference pattern.

The ZCP detecting module may include: an analog mux sequentially receiving the counter electromotive force values sampled in the floating sections of the respective phases; a converting module converting the counter electromotive force values of the respective phases sequentially transmitted from the analog mux into a digital value; a storing module sequentially storing the digital value output from the converting module; a pattern detecting circuit detecting the counter electromotive force patterns of the respective phases using the stored digital value; and a ZCP detecting circuit detecting the zero cross points (ZCPs) of the respective phases by comparing the counter electromotive force patterns with a preset reference pattern.

The controlling module may include: a position measuring circuit measuring the position of the rotor using information of positions at which the zero cross points (ZCPs) are generated; a speed measuring circuit measuring the speed of the rotor using information of a time interval at which the zero cross points (ZCPs) are generated; and a controller controlling a phase switching of the respective phases by the PWM signal generating module based on the position of the rotor and speed information of the motor.

The PWM signal generating module may include: a PWM generating circuit generating a PWM signal applied with a duty ratio determined by the controller in order to control the rotation speed of the rotor; a driving signal generating circuit generating a driving voltage for deriving the phase switching of the respective phases using the PWM signal; and a gate driver operating transistors of the inverter using the driving signal based on phase switching information of the respective phase applied from the controller.

According to another preferred embodiment of the present invention, there is provided a controlling method of a motor driving apparatus, the method including: selectively applying a direct current voltage to the respective phases of a brushless DC (BLDC) motor by a switching operation; detecting counter electromotive force patterns by sampling counter electromotive force values in floating sections of the respective phases, and detecting zero cross points (ZCPs) of the respective phases by comparing the counter electromotive force patterns and a reference pattern with each other; and determining a phase switching determining whether or not the phase switching of the respective phases is performed depending on whether or not the zero cross points (ZCPs) are detected.

The detecting of the zero cross points (ZCPs) may include: sequentially receiving, by an analog mux, the counter electromotive force values sampled in the floating sections of the respective phases; converting, by a converting module, the counter electromotive force values sequentially transmitted from the analog mux into a digital value; sequentially storing, by a storing module, the digital value; detecting, by a pattern detecting circuit, the counter electromotive force patterns of the respective phases using the stored digital value; and detecting, by a ZCP detecting circuit, position information of the zero cross points (ZCPs) of the respective phases by comparing the counter electromotive force patterns with a preset reference pattern.

In the case in which the zero cross points (ZCPs) are detected, the determining of the phase switching may include: measuring a position and a rotation speed of a rotor using position information of the detected zero cross points (ZCPs); generating a PWM signal based on the position and the rotation speed of the rotor; and controlling the performing of the phase switching of the respective phases by a switching operation of an inverter using the PWM signal.

In the case in which the zero cross points (ZCPs) are not detected, the determining of the phase switching may include: detecting position information of the counter electromotive force patterns by comparing the counter electromotive force patterns with the reference pattern; calculating positions at which the zero cross points (ZCPs) are generated, using position information; measuring a position and a rotation speed of a rotor using calculated position information of the zero cross points (ZCPs); generating a PWM signal based on the position and the rotation speed of the rotor; and controlling the performing of the phase switching of the respective phases by a switching operation of an inverter using the PWM signal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a motor driving apparatus according to a preferred embodiment of the present invention;

FIG. 2 is an entire circuit diagram showing the motor driving apparatus according to the preferred embodiment of the present invention;

FIG. 3 is a view showing a controlling method of the motor driving apparatus according to a preferred embodiment of the present invention;

FIGS. 4A to 4C are views showing circuit configurations of a ZCP detecting module according to a preferred embodiment of the present invention; and

FIGS. 5A to 5C are views showing processes of detecting a zero cross point (ZCP) of the ZCP detecting module according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a preferred embodiment of the present invention will be described in detail with reference to the accompanying drawings.

Hereinafter, a motor driving apparatus and a controlling method thereof according to a preferred embodiment of the present invention will be described in detail with reference to the accompanying drawings. A zero cross point (ZCP) refers to a point at which counter electromotive force (phase voltage) of each phase crosses a reference voltage.

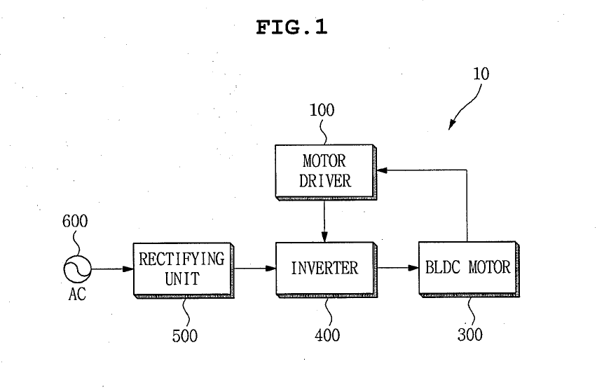

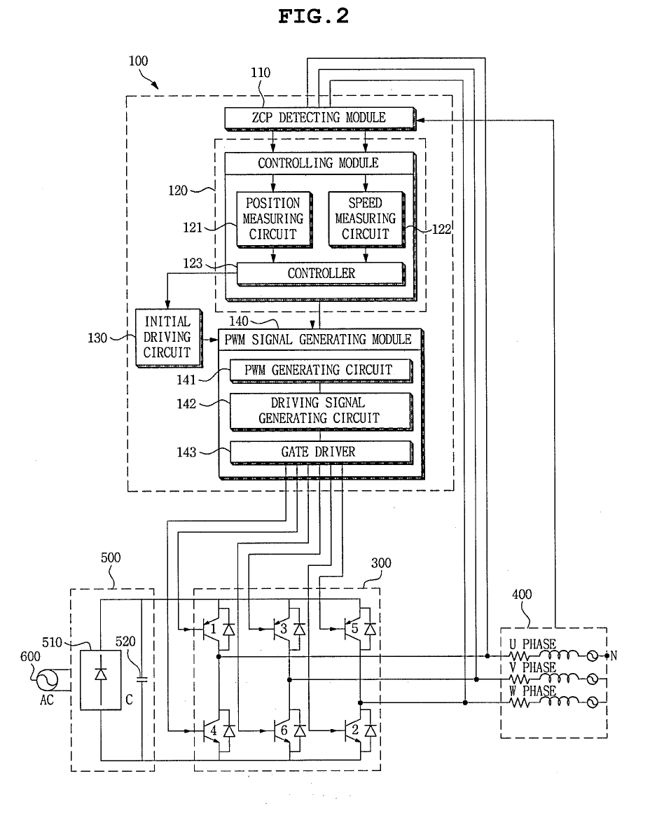

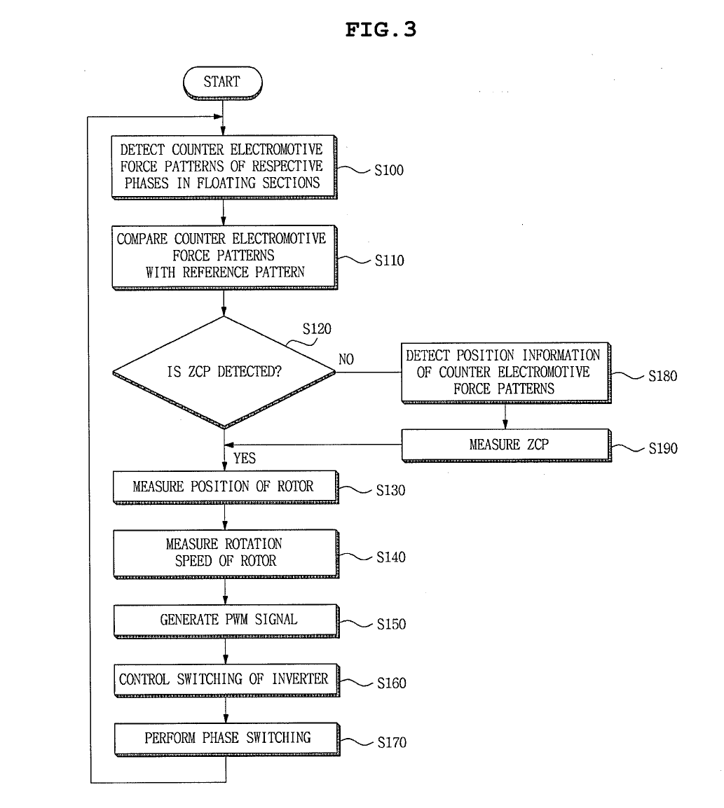

FIG. 1 is a block diagram showing a motor driving apparatus according to a preferred embodiment of the present invention, FIG. 2 is an entire circuit diagram showing the motor driving apparatus according to the preferred embodiment of the present invention, and FIG. 3 is a view showing a controlling method of the motor driving apparatus according to a preferred embodiment of the present invention.

A rectifying unit 500 includes a rectifier 510 receiving and rectifying input power (alternating current) 600 and a smoothing capacitor 520 smoothing the rectified input power 600, and applies the rectified and smoothed direct current (DC) voltage to an inverter 300.

The inverter 300 may be applied with the rectified and smoothed direct current voltage by the rectifying unit 500, may apply the direct current voltage to each phase of a BLDC motor by a switching operation, may include a transistor controlled by a PWM signal of a motor driver 100 and a diode each connected to the transistor in anti-parallel, and may be applied with the direct current voltage by a direct current (DC) power instead of the rectifying unit 500.

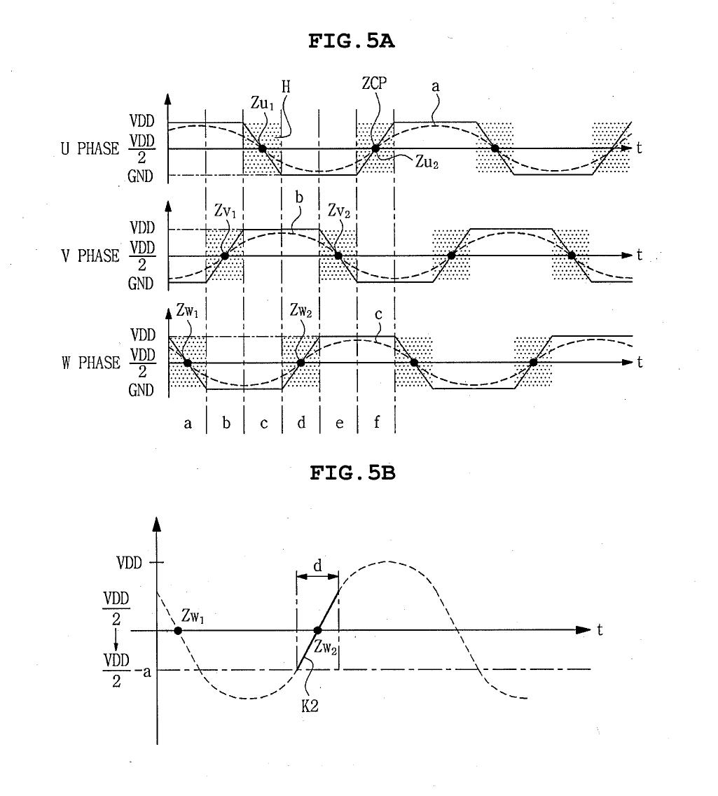

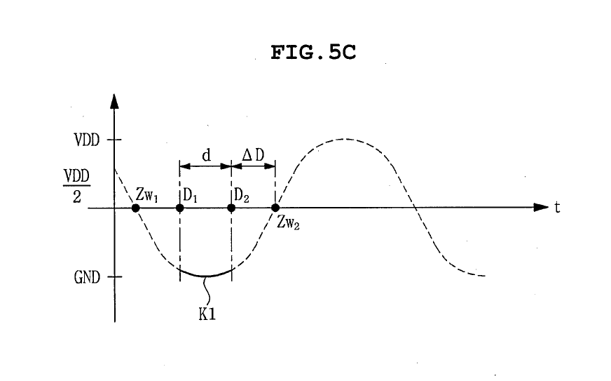

The motor driver 100 detects counter electromotive force patterns in floating sections (H of FIG. 5A) of the respective phases of the BLDC motor (S100), detects zero cross points (ZCPs) of the respective phases using the counter electromotive force patterns, and then generates the PWM signal for controlling a switching operation of the inverter and a phase switching of the respective phases using position information of the zero cross points (ZCPs).

That is, the motor driver 100 converts counter electromotive force values in the floating sections (H of FIG. 5A) of the respective phases into digital values, forms the counter electromotive force patterns consisting of the digital values, and then compares the counter electromotive force patterns with reference patterns a, b, and c (FIG. 5A) in the floating sections (H of FIG. 5A) (S110), thereby detecting the zero cross points (ZCPs) of the respective phases.

In addition, the motor driver 100 detects position information (phase, or the like) of the counter electromotive force patterns from the reference patterns a, b, and c (S180) in the case in which the zero cross points (ZCPs) are not detected because the counter electromotive force patterns and the reference patterns a, b, and c are different from each other, and performs a calculation for finding a substantial zero cross point (ZCP) based on position information (S190).

In addition, the motor driver 100 may include at least one analog-to-digital (A/D) converter converting the counter electromotive force of the respective phases into the digital values, at least one register sequentially storing the digital values, and an initial driving circuit 130 providing information for the zero cross points (ZCP) for performing the phase switching of the respective phases to a PWM signal generating module at the time of initially driving.

In addition, the motor driver 100 may include a ZCP detecting module 110, a controlling module 120, and the PWM signal generating module 140. The ZCP detecting module 110 compares the counter electromotive force patterns detected from the floating sections (section to which power is not connected) of the respective phases U, V, and W with the reference patterns to thereby detect the zero cross points (ZCP) of the respective phases, and may be configured by detecting circuits 111, 112, and 113 of the respective phases U, V, and W, a pattern detecting circuit 173, a ZCP detecting circuit 174, and the like. A detail description thereof will be made below.

The controlling module 120 may measure a position and a rotation speed of a rotor using information of the detected zero cross points (ZCPs), and the like, then control the phase switching of the respective phase, and may include a position measuring circuit 121, a speed measuring circuit 122, and a controller 123.

Here, the position measuring circuit 121 measures the position of the rotor using information of the position (see FIG. 5A) at which the zero cross points (ZCPs) are generated during a driving process of the BLDC motor (S130), the speed measuring circuit 122 measures the speed of the rotor using information of a time interval at which the zero cross points (ZCPs) are generated (S140), and the controller 123 generates the PWM signal by the PWM signal generating module based on the position of the rotor and speed information of the motor (S150) to thereby control the phase switching of the respective phases (U phase, V phase, and W phase).

The PWM signal generating module 140 generates the PWM signal for controlling a phase switching timing of the respective phases based on the position of the rotor and speed information of the motor, and includes a PWM generating circuit 141, a driving signal generating circuit 142, and a gate driver 143.

Here, i) the PWM generating circuit 141 generates the PWM signal applied with a duty ratio determined by the controller in order to control the rotation speed of the rotor, ii) the driving signal generating circuit 142 generates a driving voltage for deriving the phase switching of the respective phases using the PWM signal, iii) the gate driver 143 controls a switching operation (switch on/off) of the transistor of the inverter 300 by amplifying the driving signal based on phase switching information (the zero cross point, the detection position, and the like) of the respective phases applied from the controller 123 (S160), and the phase switching of the respective phases is performed by the switching operation of the inverter 300 (S170).

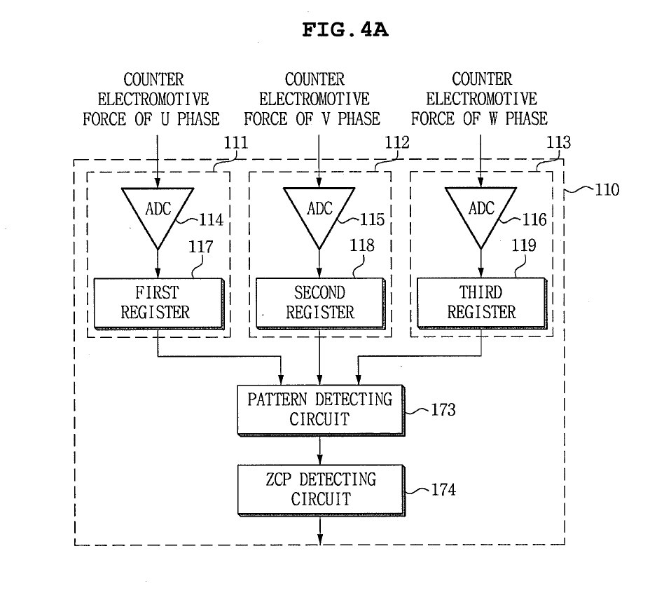

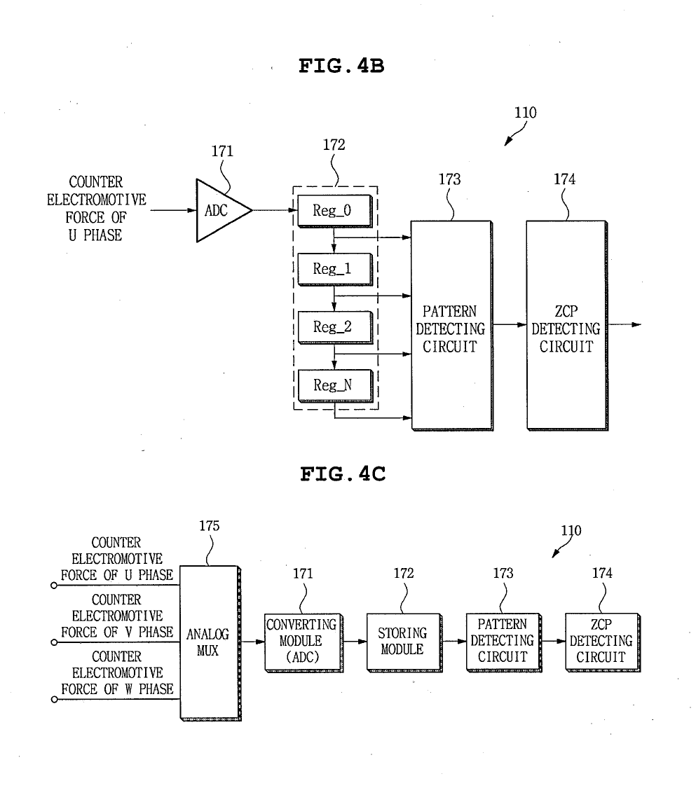

Hereinafter, a circuit configuration for detecting the zero cross points (ZCPs) in the respective phases in the ZCP detecting module according to the preferred embodiment of the present invention will be described in detail with reference to FIGS. 4A to 4C.

FIG. 4A shows a circuit configuration of the ZCP detecting module according to a preferred embodiment of the present invention, FIG. 4B is a view showing a circuit configuration of a U phase detecting circuit included in the ZCP detecting module according to the preferred embodiment of the present invention, and FIG. 4C is a view showing a circuit configuration of a ZCP detecting module according to another preferred embodiment of the present invention.

As shown in FIG. 4A, the ZCP detecting module 110 includes a U phase detecting circuit 111, a V phase detecting circuit 112, and a W phase detecting circuit 113 converting the counter electromotive values sampled in the floating sections (H of FIG. 5A) of the respective phases U, V, and W into the digital values to sequentially store the digital values, where the detecting circuits 111, 112, and 113 of the respective phases include first to third converters 114, 115, and 116 and first to third registers 117, 118, and 119 connected to the first to third converters 114, 115, and 116 in series. Here, the first to third converters 114, 115, and 116 may be analog-to-digital converters (hereinafter, referred to as ADCs), and the first to third register 117, 118, and 119 may each include at least one register, where the register may be a flip-flop.

The pattern detecting circuit 173 is applied with the counter electromotive force values of the respective phases sequentially stored in the first to third registers 117, 118, and 119 from the detecting circuits 111, 112, and 113 of the respective phases U, V, and W, and detects the counter electromotive force patterns of the respective phases using the counter electromotive force values.

The ZCP detecting circuit 174 compares the counter electromotive force patterns of the respective phases detected from the pattern detecting circuit 173 and the pre-stored reference patterns of the respective phases to thereby detect the zero cross points (ZCPs) of the respective phases from the counter electromotive force patterns. Here, the ZCP detecting circuit 174 may detect the zero cross point (ZCP) by sampling some sections (a region in which the zero cross point is generated in the reference pattern (c of FIG. 5A)) of the floating section H in order to perform the phase switching of the respective phases, and the controlling module 120 may perform the phase switching of the respective phases based on the zero cross point (ZCP).

As shown in FIG. 4B, the U phase detecting circuit 111 may include a first converter 114 converting the counter electromotive force value sampled in the floating section of the U phase into the digital value, and a first register 117 configured by a plurality of registers (Reg_{—}1 to Reg_N) in which the digital value is sequentially stored.

That is, when the counter electromotive force value sampled in the floating section of the U phase is sequentially converted into the digital value by the first converter 171, the digital value is sequentially stored in the plurality of registers from the register Reg_{—}1 to the register Reg_N and is transmitted to the pattern detecting circuit 173.

In addition, the pattern detecting circuit 173 forms the counter electromotive force pattern in the floating section of the U phase using the digital value of the counter electromotive force sequentially transmitted from the first register 117, and the ZCP detecting circuit 174 compares the counter electromotive force pattern and the pre-stored reference pattern a of the U phase (see FIG. 5A) with each other to thereby detect the zero cross point (ZCP) of the U phase. Here, the zero cross point (ZCP) of the reference pattern a of the U phase may be set as those detected at a point at which the phase of counter electromotive force is 0° and 180° of a cycle (0° to 360° (or 0°)) of counter electromotive force of the U phase, and the V and W phases detecting circuits 112 and 113 may include the same configuration and function as the U phase detecting circuit 111 as described above.

Further, as shown in FIG. 4C, the ZCP detecting module 110 may be configured to include an analog mux 175 sequentially receiving the counter electromotive force values sampled in the floating sections of the respective phases (U phase, V phase, and W phase), a converting module 171 converting the counter electromotive force values of the respective phases transmitted from the to analog mux 175 into the digital values, a storing module 172 sequentially storing the digital values output from the converting module 171, a pattern detecting circuit 173 detecting the counter electromotive force patterns of the respective phases using the stored digital values, and a ZCP detecting circuit 174 comparing the counter electromotive force patterns and the reference pattern which is pre-stored with each other to thereby detect the zero cross points (ZCPs) of the respective phases.

That is, the counter electromotive force values sampled in the floating sections of the respective phases (U phase, V phase, and W phase) are transmitted to the converting module 171 through the analog mux 175, the counter electromotive force values are converted into the digital values by the converting module 171 and are sequentially stored in the storing module 172, and the contents that the zero cross patterns (ZCPs) are detected by forming the counter electromotive force patterns of the respective phases by the pattern detecting circuit 173 and the ZCP detecting circuit 174 are the same as those described above.

Here, the converting module 171 may be an analog-to-digital converter, and the storing module 172 may include at least one register, where the register may be a flip-flop.

As described above, the counter electromotive force patterns in the floating sections of the respective phases are detected by the ZCP detecting module of the BLDC motor driving apparatus and are then compared to the reference pattern of the respective phases which are pre-stored, such that the zero cross points (ZCPs) of the respective phases may be more accurately detected.

In addition, in detecting the zero cross points (ZCPs) of the respective phases, in order to compare between the counter electromotive force of the respective phases and the reference voltage, the zero cross points (ZCPs) of the respective phases are detected by the analog mux, one digital-to-analog converter (ADC), and the storing module (register) instead of including the comparator per each phase, thereby making it possible to implement slimness and lightness of the entire motor driving apparatus.

Hereinafter, processes for detecting the zero cross points (ZCPs) in the floating sections of the respective phases in the ZCP detecting module according to the preferred embodiment of the present invention will be described in detail with reference to FIGS. 5A to 5C.

FIG. 5A is a view showing a waveform and a reference pattern of counter electromotive force in the respective phases (U phase, V phase, and W phase) of the BLDC motor, and FIGS. 5B and 5C are views showing a detection of the zero cross point (ZCP) using the counter electromotive force pattern in the floating section in the W phase.

As shown in FIG. 5A, the phase voltage of the respective phases of the BLDC motor is changed in a trapezoidal shape, and the respective phases (U phase, V phase, and W phase) include a section to which power (V_{dd}) is applied, a ground section (GND), and a floating section (a section to which power is not applied) H (a dotted line region). In addition, through a to f steps, the rotor (not shown) of the motor is rotated 360°, and in general, when the zero cross point (ZCP) is detected, the phase switching is performed after an electrical angle of 30° therefrom.

Here, when the rotor of the BLDC motor is rotated 360°, counter electromotive force a, b, and c of the respective phases (U phase, V phase, and W phase) are changed in a sine wave shape, and counter electromotive force of the respective phases and the zero cross points (ZCPs) may be detected only in the floating section H. Therefore, 1) in the reference pattern a for counter electromotive force of the U phase, the zero cross point (ZCP) may be detected at a point at which the phase of counter electromotive force is 0° (Z_{U1}) and 180° (Z_{U2}) of the cycle (0° to 360° (or 0°)) of counter electromotive force of the U phase, 2) in the reference pattern b for counter electromotive force of the V phase, the zero cross point (ZCP) may be detected at a point at which the phase of counter electromotive force is 0° (Z_{V1}) and 180° (Z_{V2}) of the cycle (0° to 360° (or 0°)) of counter electromotive force of the V phase, and 3) in the reference pattern c for counter electromotive force of the W phase, the zero cross point (ZCP) may be detected at a point at which the phase of counter electromotive force is 0° (Z_{W1}) and 180° (Z_{W2}) of the cycle (0° to 360° (or 0°)) of counter electromotive force of the W phase.

In addition, as shown in FIG. 5B, the counter electromotive force value is sampled in the floating section d (see FIG. 5A) of the W phase and is input to the converting module 171 through the analog mux 175, the counter electromotive force value is converted into the digital value by the converting module 171 and is then sequentially stored in the storing module 172, the pattern detecting circuit 173 forms a counter electromotive force pattern K2 using the digital value stored in the storing module 172, and the ZCP detecting circuit 174 may detect the zero cross point Z_{W2} (the point at which the phase is 0° or 360°) when the counter electromotive force pattern K2 and the reference pattern c in the floating section d are the same as each other by comparing the counter electromotive force pattern K2 and the reference pattern c in the floating section d with each other. Here, the counter electromotive force value may be sampled 80 to 84 times in the floating section H.

However, as shown in FIG. 5C, in the case in which a counter electromotive force pattern K1 formed using the counter electromotive force value sampled in the floating section d (see FIG. 5A) of the W phase is different from the reference pattern c in the floating section d, a phase difference between the counter electromotive force pattern K1 detected from the floating section d (see FIG. 5A) and the substantial zero cross point Z_{W2} is detected by detecting phases D₁ and D₂ of sections in which the counter electromotive force pattern K1 is formed in the cycle (0° to 360° (or 0°)) of the reference pattern (c of FIG. 5A) of the W phase and then calculating a phase difference (ΔD) between the detected phase D₂ and the zero cross point Z_{W2} in the reference pattern (c of FIG. 5A), and the detection of the zero cross point and the phase switching of the W phase may be more accurately performed based on the detected phase difference. Here, although the specification describes the process forming the counter electromotive force pattern using the counter electromotive force value sampled in the floating section based on the W phase and then detecting the zero cross point (ZCP) using the formed counter electromotive force pattern, the above-mentioned process may be equally applied to the U phase and the V phase.

According to the preferred embodiment of the present invention, the counter electromotive force patterns in the floating sections of the respective phases are detected by the ZCP detecting module of the BLDC motor driving apparatus and are then compared to the reference patterns of the respective phases which are pre-stored, such that the zero cross points (ZCPs) of the respective phases may be more accurately detected.

In addition, in the sensor-less scheme detecting position information of the rotor by detecting the zero cross points (ZCPs) by the changes in the counter electromotive force of the respective phases, even in the case in which the crossing between the counter electromotive force and the reference voltage does not occur due to the mismatching or the like of the inductor or the like of the motor, the accuracy of the detection of the zero cross points (ZCPs) and the phase switching timings of the respective phases may be secured and the optimal BLDC motor control may be further implemented by converting the counter electromotive force values in the floating sections of the respective phases into the digital values, forming the counter electromotive force patterns consisting of the digital values, and then comparing the counter electromotive force patterns and the pre-stored reference patterns with each other to thereby detect the zero cross points (ZCPs) of the respective phases.

In addition, in detecting the zero cross points (ZCPs) of the respective phases, in order to to compare between the counter electromotive force of the respective phases and the reference voltage, the zero cross points (ZCPs) of the respective phases are detected by the analog mux, one digital-to-analog converter (ADC), and the storing module (register) instead of including the comparator per each phase, thereby making it possible to implement slimness and lightness of the entire motor driving apparatus.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A motor driving apparatus, comprising:
an inverter applying a direct current voltage to the respective phases of a brushless DC (BLDC) motor by a switching operation; and
a motor driver detecting counter electromotive force patterns of the respective phases by sampling counter electromotive force values in floating sections of the respective phases, and detecting zero cross points (ZCPs) of the respective phases by comparing the counter electromotive force patterns and a reference pattern with each other.

2. The apparatus as set forth in claim 1, wherein the motor driver generates a PWM signal for controlling a switching operation of the inverter and a phase switching of the respective phases using position information of the zero cross points (ZCPs).

3. The apparatus as set forth in claim 1, wherein the inverter includes transistors controlled by the PWM signal of the motor driver and diodes each connected to the transistors in anti-parallel.

4. The apparatus as set forth in claim 1, wherein the motor driver forms the counter electromotive force patterns of the respective phases by converting the sampled counter electromotive force values into digital values and sequentially storing the digital values and then detects the zero cross points (ZCPs) of the respective phases by comparing the counter electromotive force patterns with a preset reference pattern.

5. The apparatus as set forth in claim 1, wherein the motor driver includes:
at least one analog-to-digital (A/D) converter converting the sampled counter electromotive force values of the respective phases into digital values; and
at least one register sequentially storing the digital values.

6. The apparatus as set forth in claim 5, wherein the register is a flip-flop.

7. The apparatus as set forth in claim 1, wherein the motor driver includes:
a ZCP detecting module detecting the zero cross points (ZCPs) of the respective phases by comparing the counter electromotive force patterns detected in the floating sections of the respective phases with the reference pattern;
a controlling module measuring a position and a rotation speed of a rotor using information of the detected zero cross points (ZCPs); and
a PWM signal generating module generating a PWM signal for controlling phase switching timings of the respective phases based on the position of the rotor and speed information of the motor.

8. The apparatus as set forth in claim 7, wherein the motor driver includes an initial driving circuit providing information for the zero cross points (ZCPs) for performing the phase switching of the respective phases to the PWM signal generating module at the time of initially driving.

9. The apparatus as set forth in claim 7, wherein the ZCP detecting module includes:
a U phase detecting circuit including a first converter converting a counter electromotive force value sampled in a floating section of a U phase into a digital value and a first register sequentially storing the digital value;
a V phase detecting circuit including a second converter converting a counter electromotive force value sampled in a floating section of a V phase into a digital value and a second register sequentially storing the digital value;
a W phase detecting circuit including a third converter converting a counter electromotive force value sampled in a floating section of a W phase into a digital value and a third register sequentially storing the digital value;
a pattern detecting circuit detecting the counter electromotive force patterns of the respective phases using the digital value stored in the first to third registers; and
a ZCP detecting circuit detecting the zero cross points (ZCPs) of the respective phases by comparing the counter electromotive force patterns with a preset reference pattern.

10. The apparatus as set forth in claim 7, wherein the ZCP detecting module includes:
an analog mux sequentially receiving the counter electromotive force values sampled in the floating sections of the respective phases;
a converting module converting the counter electromotive force values of the respective phases sequentially transmitted from the analog mux into a digital value;
a storing module sequentially storing the digital value output from the converting module;
a pattern detecting circuit detecting the counter electromotive force patterns of the respective phases using the stored digital value; and
a ZCP detecting circuit detecting the zero cross points (ZCPs) of the respective phases by comparing the counter electromotive force patterns with a preset reference pattern.

11. The apparatus as set forth in claim 7, wherein the controlling module includes:
a position measuring circuit measuring the position of the rotor using information of positions at which the zero cross points (ZCPs) are generated;
a speed measuring circuit measuring the speed of the rotor using information of a time interval at which the zero cross points (ZCPs) are generated; and
a controller controlling a phase switching of the respective phases by the PWM signal generating module based on the position of the rotor and speed information of the motor.

12. The apparatus as set forth in claim 11, wherein the PWM signal generating module includes:
a PWM generating circuit generating a PWM signal applied with a duty ratio determined by the controller in order to control the rotation speed of the rotor;
a driving signal generating circuit generating a driving voltage for deriving the phase switching of the respective phases using the PWM signal; and
a gate driver operating transistors of the inverter using the driving signal based on phase switching information of the respective phase applied from the controller.

13. A controlling method of a motor driving apparatus, the method comprising:
selectively applying a direct current voltage to the respective phases of a brushless DC (BLDC) motor by a switching operation;
detecting counter electromotive force patterns by sampling counter electromotive force values in floating sections of the respective phases, and detecting zero cross points (ZCPs) of the respective phases by comparing the counter electromotive force patterns and a reference pattern with each other; and
determining a phase switching determining whether or not the phase switching of the respective phases is performed depending on whether or not the zero cross points (ZCPs) are detected.

14. The method as set forth in claim 13, wherein the detecting of the zero cross points (ZCPs) includes:
sequentially receiving, by an analog mux, the counter electromotive force values sampled in the floating sections of the respective phases;
converting, by a converting module, the counter electromotive force values sequentially transmitted from the analog mux into a digital value;
sequentially storing, by a storing module, the digital value;
detecting, by a pattern detecting circuit, the counter electromotive force patterns of the respective phases using the stored digital value; and
detecting, by a ZCP detecting circuit, position information of the zero cross points (ZCPs) of the respective phases by comparing the counter electromotive force patterns with a preset reference pattern.

15. The method as set forth in claim 13, wherein in the case in which the zero cross points (ZCPs) are detected, the determining of the phase switching includes:
measuring a position and a rotation speed of a rotor using position information of the detected zero cross points (ZCPs);
generating a PWM signal based on the position and the rotation speed of the rotor; and
controlling the performing of the phase switching of the respective phases by a switching operation of an inverter using the PWM signal.

16. The method as set forth in claim 13, wherein in the case in which the zero cross points (ZCPs) are not detected, the determining of the phase switching includes:
detecting position information of the counter electromotive force patterns by comparing the counter electromotive force patterns with the reference pattern;
calculating positions at which the zero cross points (ZCPs) are generated, using position information;
measuring a position and a rotation speed of a rotor using calculated position information of the zero cross points (ZCPs);
generating a PWM signal based on the position and the rotation speed of the rotor; and
controlling the performing of the phase switching of the respective phases by a switching operation of an inverter using the PWM signal.
